(19) United States
(12) Patent Application Publication
(10) Pub. No.: US 2007/0054678 A1
(43) Pub. Date: Mar. 8, 2007

(54) Method of generating a sms or mms text message for receipt by a wireless information device

(75) Inventor: Daniel Michael Doulton, London (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: Spinvox Limited, London (GB)

(21) Appl. No.: 10/554,022

(22) PCT Filed: Apr. 22, 2004
(86) PCT No.: PCT/GB04/01738

§ 371 Date: Oct. 21, 2005

(51) Int. Cl. H04Q 7/20

(52) U.S. Cl. 455/466

(57) ABSTRACT

A spoken message that a user wishes to have converted to a SMS or MMS message is received at a voicemail server and converted to an audio file format; it is then sent or streamed over a wide area network to a voice to text transcription system comprising a network of computers. One of the networked computers plays back the voice message to an operator and the operator intelligently transcribes the actual message from the original voice message by entering the corresponding text message (actually a succinct version of the original voice message, not a verbose word-for-word conversion) into the computer to generate a transcribed text message. The transcribed text message is then sent to the wireless information device from the computer as a SMS or MMS text message. Because human operators are used instead of machine transcription, voicemails are converted accurately, intelligently, appropriately and succinctly into text messages (SMS/MMS).

### BACKGROUND OF THE INVENTION

1. Field of the Invention

This invention relates to a method of generating a SMS or MMS text message for receipt by a wireless information device. The term ‘wireless information device’ used in this patent specification should be expansively construed to cover any kind of device with two way wireless information capabilities and includes without limitation radio telephones, smart phones, communicators, wireless messaging terminals, personal computers, computers and application specific devices. It includes devices able to communicate in any manner over any kind of network, such as GSM or UMTS, CDMA and WCDMA mobile radio, Bluetooth, IrDA etc.

2. Description of the Prior Art

SMS text messaging is the most successful mobile telephony data service. The GSM association forecast that 200 billion text messages would be sent over the worldwide GSM networks during 2001 and 360 billion during 2002. In January 2004 the Mobile Data Association (MDA) estimated that 20.5 billion text messages were sent in the UK during 2003, with a daily average in December of 61 million text messages (51m yearly daily average), The MDA forecast that text messaging will reach 23 billion in 2004 in the UK and Mobile Lifestreams (Independent Research Firm) report that an average of 27 billion text messages were sent each month in Europe during 2003.

Currently however SMS usage is confined to young people and some business users. One of the major barriers to greater uptake is that creating a SMS message requires the user to input text using the small keys of the mobile telephone; this is slow and for many users far too intricate. The use of automated voice recognition systems could solve this. For example, automated voice to text conversion can in theory be deployed within a mobile telephone itself: reference may be made to the Nokia Short Voice Messaging system (see EP 1248486) in which a user can speak a message to his mobile telephone, which locally converts it to text using an automated voice recognition engine and then packages and sends it as a SMS message. This clearly avoids the need for the user to input text using the small numeric keys of the mobile telephone. However, automated voice transcription systems have quite limited performance and accuracy; they also slavishly transcribe the normal hesitations in human speech (‘er’, ‘um’, ‘ah’ etc.). When one is listening to human speech, one can readily filter out these sounds and concentrate on the substantive communication. Seeing these hesitations slavishly transcribed to a SMS mail can make the sender appear less then lucid. Hence, whilst SMS generation using voice to text conversion avoids the need to input a text message using the small keys of a mobile telephone, it does not address the inherent inaccuracy and inappropriate transcription of conventional automated voice recognition software.

The overwhelming bias in the field of voice to text conversion systems is in improving the accuracy of automated voice recognition software; current generation software nevertheless still either needs to be trained to recognise words spoken by a specific person or is limited to recognising a very limited vocabulary and has huge difficulties with context. Training requires the user to read out quite extensive test passages and to then correct the transcription errors introduced by the machine transcription. This is a slow and arduous task.

The task of constructing voice recognition software that can reliably and accurately recognise natural speech relating to any subject, from anyone and spoken at normal speed, remains a daunting one. Nevertheless, it remains the over-riding goal in the area of voice to text systems. The present invention challenges this orthodoxy.

### SUMMARY OF THE INVENTION

1. A method of generating a SMS or MMS text message for receipt by a wireless information device, comprising the steps of:

(a) receiving a voice message at a server,
(b) converting the voice message to an audio file format;
(c) sending or streaming the audio file over a wide area network to a voice to text transcription system comprising a network of computers;
   wherein the method is characterised by the steps of:
(i) one of the networked computers playing back the voice message to an operator;
(ii) the operator intelligently transcribing the original voice message into the computer to generate a transcribed text message;
(iii) the operator causing the transcribed text message to be sent to the wireless information device from the computer as a SMS or MMS message.

Because human operators are used instead of machine transcription, voicemails are converted accurately, intelligently, appropriately and succinctly into text messages (SMS/MMS).

The present invention therefore enables a user to send someone a SMS or MMS text message even when that user is unable or unwilling to use the text messaging capabilities of his phone. Text messaging on mobile phones requires you to type on unnaturally small and fiddly alpha-numeric keypads, often with confusing pre-emptive text editors. This often takes quite some time to master and can take 2 to 3 minutes to thumb-type a short message. Instead, with the present invention, the user can speak the message to a remote server, which passes a voice file with the spoken message for transcription to the human based voice transcription system; this system then transcribes the message to SMS or MMS text message format and then sends the text message to the desired recipient.

In one implementation from SpinVox, the following steps occur
1. User presses one button on his telephone (mobile or landline) and is connected to SpinVox's VoiceMessenger service.
2. The user says the number he wants to send the message to, or types it in to the keypad of his telephone.

Note: Initiating the spoken text message from a phone's address book is also possible.
3. He dictates the message.
4. The voice message is sent to the text transcription infrastructure and transcribed to a text message
5. The text message is sent as if from the user and received

Fast
Use the power of voice to get basic tasks done
Takes seconds not minutes

Convenient
No need to look down at a small screen and tiny numeric keypad to thumb-type message
Can be used whilst multi-tasking—e.g. driving, walking, reading, navigating, etc. . . .

Dial Into Your Account From Any Landline
Create a speed-dial on your desk-phone, then just speak the message

Accurate
Real words, not text'isms, spell checked, real noun-checked, grammar checked

Easy
No learning or training
   Billing

There are two choices—Pre-pay or post pay either via micro-billing on the user's phone bill or credit/debit card and direct debit monthly payments. In fact any payment method available at the time via 3^{rd} party Merchant Service providers, so even PayPal which is largely a US phenomenon, is becoming available in Europe as a valid payment method.

Credit/Debit Card

Users will be able to sign-up with credit/debit cards for automatic monthly payments, including Direct Debit (UK) and PayPal for the US.

Micro-Billing

Users will be able to buy SpinVox credit (e.g. £10's worth) via a single reverse billed SMS which will confirm their new credit. Typically this will appeal to the pre-paid market. This neatly avoids the relatively expensive cost (60%+) of many individual micro-transactions each time they use the Services which otherwise make this too expensive and encourages some commitment from the user to the service.

### BRIEF DESCRIPTION OF THE DRAWINGS

The present invention will be described with reference to the accompanying drawings, in which:

FIGS. 1-3 are schematics of an entire voicemail process, starting from voicemail origination, voicemail processing and voicemail delivery; in accordance with the present invention;

FIG. 4 depicts the format of a message notification (displayed in a messages in-box on a mobile telephone) for a voicemail transcribed using the method of the present invention;

FIG. 5 depicts a conventional text message notification;

FIG. 6 depicts how a voicemail transcribed using the method of the present invention appears as a text message displayed on a mobile telephone;

FIG. 7 depicts a mobile telephone displaying a list of text messages in a messages in-box. A transcribed voice mail is present in the list; the callout shows how it would be displayed if selected;

FIG. 8 depicts a menu list of three new functions available as options relevant to a transcribed voicemail;

FIGS. 9A to 9D depict a GUI based voicemail management application for managing conventional audio voicemails;

FIG. 10 depicts the operation of an application that enables a user to speak a message into his mobile telephone and have that remotely converted to a text message;

FIG. 11 shows the overall flow of actions at a voicemail server, indicating the actions initiated by user inputs;

FIG. 12 shows the overall flow of actions occurring at the voice message transcribers;

FIG. 13 shows a screen shot of the web-based interface used by voice message transcribers.

### DETAILED DESCRIPTION

The present invention is implemented by SpinVox Limited, London, United Kingdom as part of a suite of mobile telephone products:
1. VoicemailView™: Voicemail to Text system—This gives subscribers the option to have voicemail delivered to their mobile telephone as text (SMS/MMS or equivalent messaging format) with the option to hear the original voicemail on the mobile telephone. The term ‘SMS’ means the short message service for sending plain text messages to mobile telephones; ‘MMS’ means the multimedia messaging service developed by 3GPP (Third Generation Partnership Project) for sending multimedia communications between mobile telephones and other forms of wireless information device. The terms also embrace any intermediary technology (such as EMS Enhanced Message Service)) and variants, such as Premium SMS, and any future enhancements and developments of these services.
2. VoicemailManager™: A new Voicemail Management Application—This adds a GUI (graphical user interface) to the mobile telephone; it supplements (or replaces) the existing audio menu system (UI) provided by cellular phone voicemail systems and integrates the phone's call divert features, greetings controls and other related controls to provide a single environment (application) on the mobile telephone for voicemail management.
3. VoiceMessenger™: Speech to Text system—This allows users to speak a text message into their mobile telephone, have it converted to text remotely and then sent without using the often tiring alphanumeric phone-pad entry system.

Key to the accurate transcription of voice messages to text format (as deployed in VoicemailView and VoiceMessenger) is the use of human operators to do the actual transcribing intelligently by extracting the message (not a verbose word-for-word transcription), and not automated voice recognition systems. Key to the efficient operation of this system is an IT architecture that rapidly sends voice files to the operators and allows them to rapidly hear these messages, efficiently generate a transcription and to them send the transcribed message as a text message.

A. VoicemailView™ Voicemail to Text System

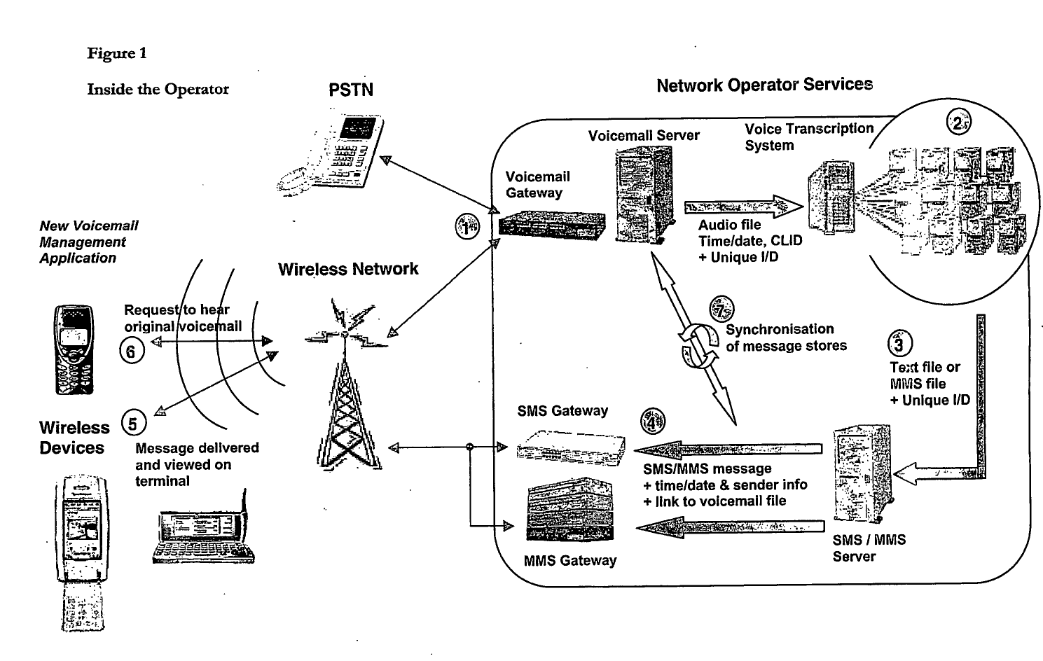

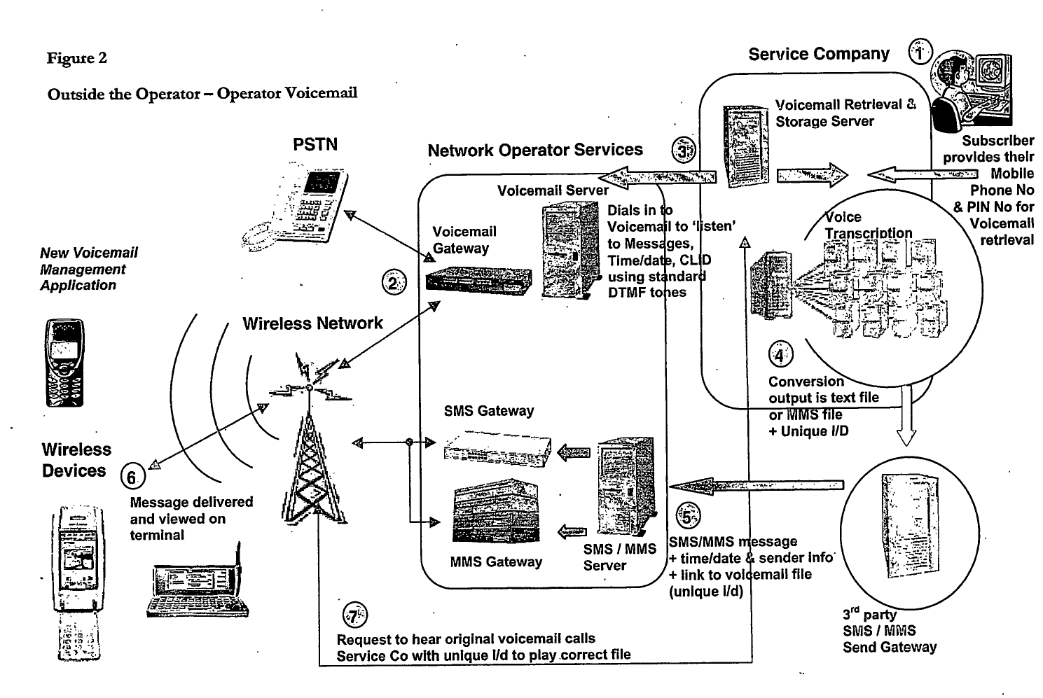

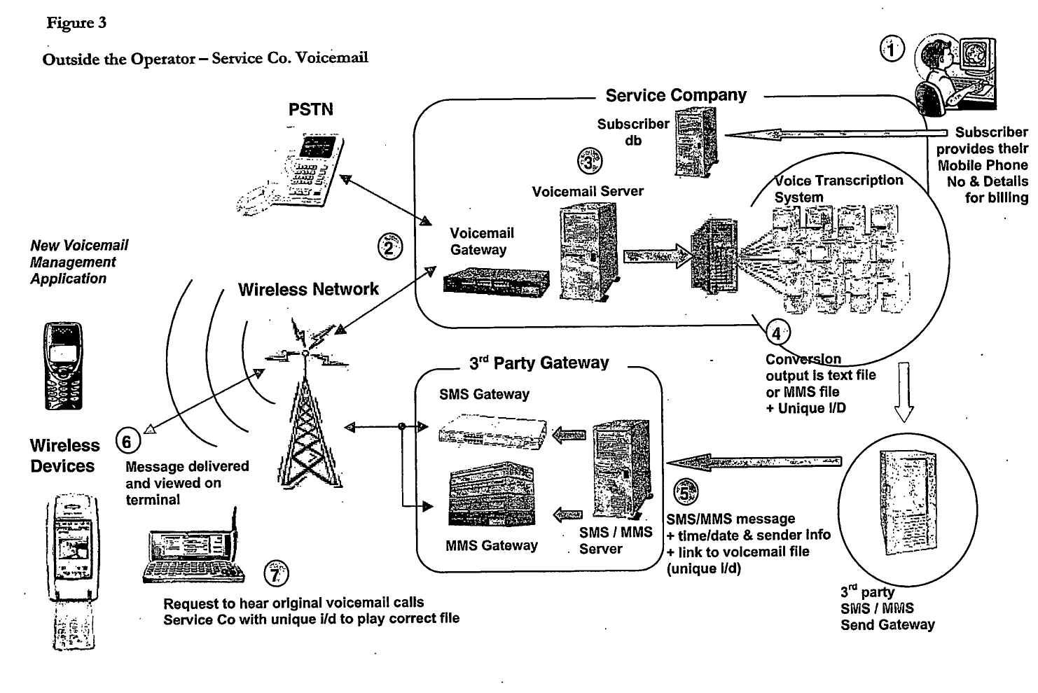

There are three solutions described which deliver the Voicemail to Text system:
1. Inside the Network Operator—the system is integrated within an operator's Network Services (see FIG. 1).
2. Outside the Network Operator—a Service Company accesses the Network Operator's Voicemail system via fixed telephony and provides an external service direct to end users; see FIG. 2, or houses its own voicemail system and delivers its service completely outside the Network Operator's service and is therefore network operator and handset independent, see FIG. 3.
   A.1 VoicemailView: Inside the Operator Variant
   Referring now to FIG. 1, the process deployed is as follows:
1 Caller, from either PSTN or Mobile phone network, leaves a voicemail.
2 Voicemail is converted into a SMS or MMS file by the voice transcription service: this is done not by automatic voice recognition systems, but instead by human operators. These operators are far more accurate and flexible than automated voice recognition systems and can intelligently interpret the message, eliminating unnecessary hesitations and repetitions to generate a short, simple and lucid message. Appendix II defines the requirements for effective and succinct transcription. The operators will often be able to significantly shorten messages to fit them within the current SMS text message ceiling of 160 characters (or else fit longer messages into multiple SMS messages via standard concatenation); with MMS however, there is no such ceiling.
   A link (unique i/d) to the original voicemail file is generated—this i/d can just be a Hash of the time/date & caller number
   The time & date of voicemail is added to a header of the SMS/MMS file
   The caller number is added to the header of the SMS/MMS file
3 Message file is sent to SMS or MMS servers for storage.
4 Message is sent via SMS or MMS gateway to wireless terminal.
5 User views and manages ‘text’ voice mails within SMS or MMS application, or even inside a Messaging Application depending on platform.
6 User can request to hear the original voice mail through the new VoicemailManager application (which provides a GUI interface for all voicemail functions; see B.2) running on the terminal: Play, FFW, REW, Next, Erase, Store, Forward, Time/date of message, Call back (and any other existing voicemail controls available through audio prompts/menus).
7 Positive delivery of SMS/MMS synchronises the SMS/MMS store with Voicemail store as message ‘read’.
   A.2 Outside the Operator Variant; Service Company Provides Voice to Text Infrastructure for an Operator
   Referring now to FIG. 2, the process deployed is as follows:
1 New subscriber provides the Service Company with their phone number, voicemail box PIN No. and other details. This now enables the Voicemail Retrieval and Storage Server to call into their voicemail box to retrieve messages by polling it regularly, or the Voicemail system inside the Operator sending it notifications of new voicemails. There are 2 options (either pre-paid or post-pay) for user billing:
   1. Reverse Text billing (micro-billing)
   2. Monthly Credit/Debit Card billing
2 Caller, from either PSTN or Mobile phone network, leaves a voicemail.
3 Service Co. Voicemail Retrieval & Storage Server calls into Subscriber's Voicemail Box & ‘listens’ to messages:
   Uses standard DTMF tones to play messages, retrieve time of call, caller number and other data to build up necessary data for text delivery
   Creates unique i/d—can just be a Hash of the time/date & caller number
   Stores voicemail for future playback
4 Voicemail audio file sent to the human operator based Voice Transcription system and converted into SMS or MMS file and sent to a 3^{rd} party SMS/MMS gateway for delivery
   Link (unique i/d) to original voicemail file is generated and embedded as information hidden from the user in the SMS/MMS file
   Time & date of voicemail added to a header of the SMS/MMS file
   Caller number is added to the header of the SMS/MMS file
   MMS file can contain original audio file embedded for local playback
5 SMS or MMS message delivered via subscriber's Network Operator
   Message sent via SMS or MMS gateway to wireless terminal.
   User views and manages ‘text’ voice mails within SMS or MMS application, or even inside Messaging Application depending on platform.
6 User can dial into their voicemail on the Network using the new Voicemail Management Application (this provides the GUI; see B.2) on terminal: Play, FFW, REW, Next, Erase, Store, Forward, Time/date of message, Call back and any other existing voicemail controls available through audio prompts/menus.
7 To hear the original voicemail, the user is connected back to the Service Company's Voicemail Storage server. The unique i/d (hidden from the user in the SMS/MMS message) retrieves the correct file to play back.
   A.3 Outside the Operator: Voicemail Provided Entirely by Service Company
   Referring now to FIG. 3, the process deployed is as follows:
1 New subscriber provides Service Co. with their phone number and billing details. They are now using the Service Co. as their voicemail provider.

2 Options:
1. They manually divert calls on their phone to Service Co. Voicemail gateway number
2. Service Co. provides over-the-air upgrade to change this behaviour

There are 2 options (either pre-paid or post-pay) for billing:
3. Reverse Text billing (micro-billing)
4. Monthly Credit/Debit Card billing
2 Caller, from any phone, typically PSTN or Mobile phone network, leaves a voicemail.
3 Service Co. Voicemail provides all voicemail functions
   1. Stores voicemail for future playback
   2. Creates a unique i/d—can just be a Hash of the time/date & caller number
4 Voicemail audio file sent to human based Voice Transcription system and converted by human operators into a SMS or MMS file and sent to a 3^{rd} party SMS/MMS gateway for delivery
   Link (unique i/d) to original voicemail file generated and embedded as information in SMS/MMS file hidden from the user
   Time & date of voicemail is added to the header of the SMS/MMS file
   Caller number is added to the header of the SMS/MMS file
   MMS file can contain original audio file embedded for local playback
5 SMS or MMS message delivered via subscriber's Network Operator
   Message sent via SMS or MMS gateway to wireless terminal.
   User view and manages ‘text’ voice mails within SMS or MMS application, or even inside Messaging Application depending on platform.
6 User can dial into their voicemail on the Network using either the standard IVR controls, or the new Voicemail Management Application (provides GUI; see B.2) on terminal: Play, FFW, REW, Next, Erase, Store, Forward, Time/date of message, Call back and any other existing voicemail controls available through audio prompts/menus.
7 To Hear the original voicemail, the user is connected back to the Service Company's Voicemail Storage server. The unique i/d (hidden from the user in the SMS/MMS message) retrieves the correct file to play back.
   B. Mobile Telephone Software

In any of the above variants, the mobile phone (or other wireless information device of some nature) will need to be upgraded OTA (Over the Air) or otherwise, in the following manner:

B.1 Viewing Voicemail-Text Messages

There are two options:
1. Do not modify the existing telephone GUI—just treat the SMS which is the transcribed voicemail as another message
2. Modify the GUI to incorporate the new features shown below:

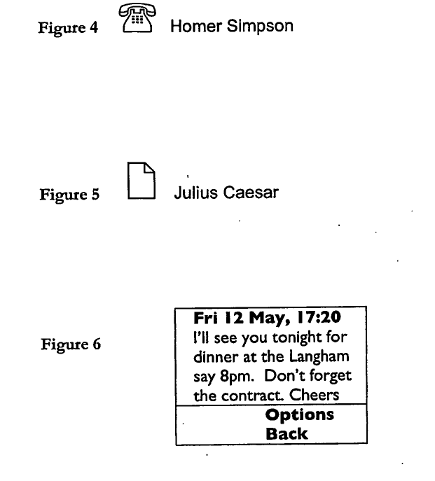

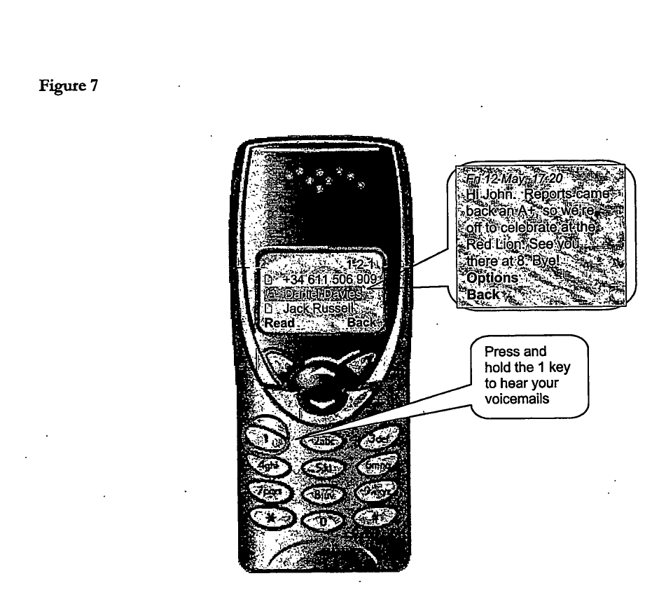

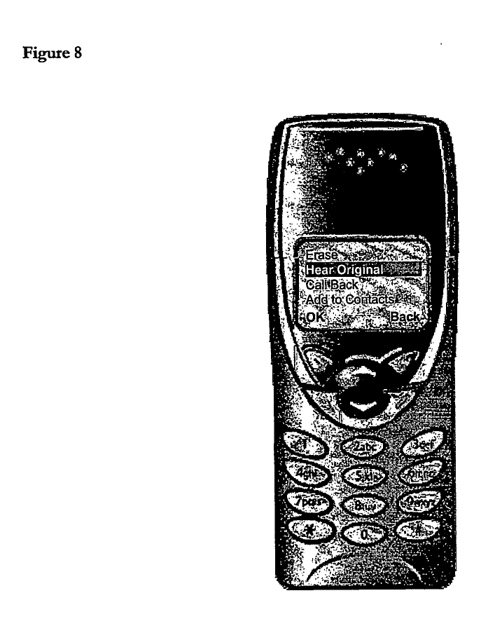

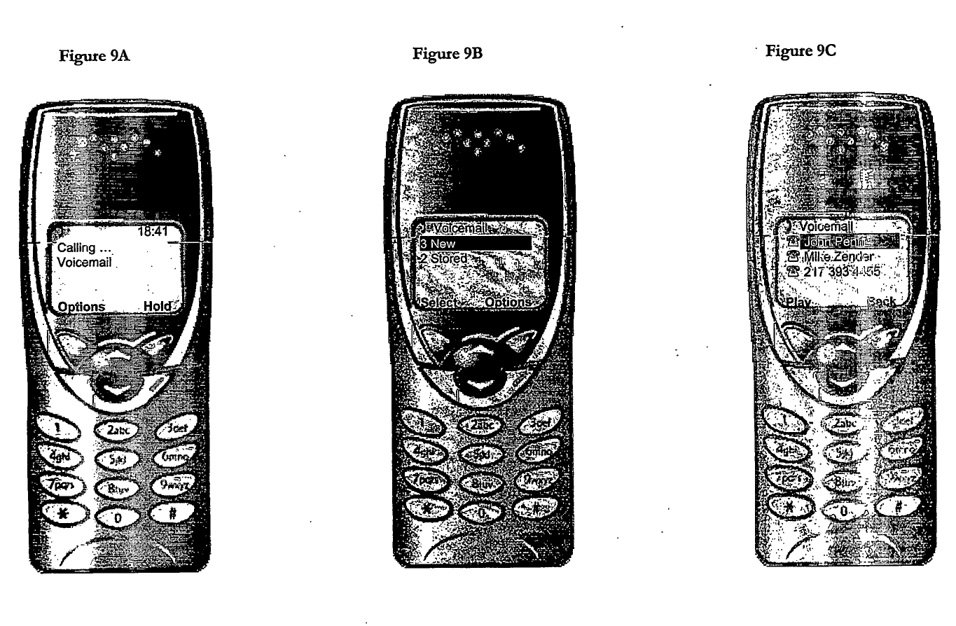

FIG. 4 shows a telephone handset icon that could be used next to a SMS message to indicate that it is a voicemail message in the messages inbox. A voicemail transcribed to text is present in the device's messages in-box; it has been sent from Homer Simpson. FIG. 5 shows what the current SMS text icon looks like. Another solution would be to precede each header with something logical such as “V:” for voicemail—hence “V: Homer Simpson” would indicate a SMS transcribed voice mail from Homer Simpson. In addition, inside the text file for the voicemail message, the time and date of the voicemail should be added (as not all gateways correctly timestamp sent messages), as shown in FIG. 6. FIG. 7 shows this in the context of a mobile telephone. The user has selected the ‘Read’ option for the highlighted transcribed voicemail (from Daniel Davies); the device displays the SMS in the normal manner, but with data and time added. It is also possible, just by pressing and holding a given key (in this illustration, key ‘1’) to activate the normal audio-based voicemail playback function.

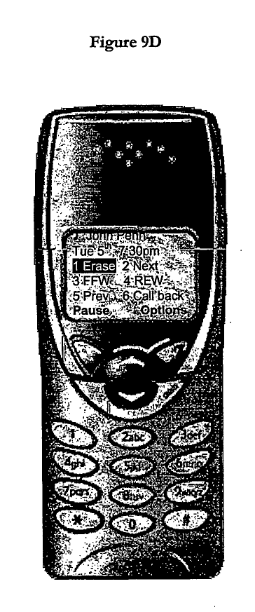

When one opens a standard SMS message, one can generally readily access further functionality (via an Options menu in Nokia mobile telephones, for example), such as ‘Erase’, ‘Reply’, ‘Edit’ etc. Under this standard ‘Options’ menu, or equivalent, the present implementation adds three new functions, as shown in FIG. 8:
Hear Original
Call Back
Add to Contacts

We expand on these new functions below.

Hear Original: This allows the user to now hear the original voicemail and uses the unique i/d encoded into the SMS/MMS message to correctly connect to the original voice file.

There are three options:
(i) The user goes into the standard voicemail system and follows the existing audio prompts for hearing the message.
(ii) The user goes into the new Voicemail Management Application shown below at B.2.

In either case, upon ending the call to voicemail, the user is returned to the same point in the messaging application to decide what to do with the text/audio version.
(iii) The user embeds the original sound file in an MMS message (or equivalent, such as e-mail to be played back locally on the terminal.
   Call Back

This uses the caller's number recorded with the message to call them back.

Add to Contacts

This takes the caller's number and automatically adds it to a new contact/address entry for the user to complete with name, etc.

This is a specific example of the mobile telephone software being able to parse the text that has been converted from voice and to use that intelligently. Other examples are:
(a) extracting the phone number spoken allowing it to be used (to make a call), saved, edited or added to a phone book;
(b) extracting an email address and allowing it to be used, saved, edited or added to an address book;
(c) extracting a physical address and allowing it to be used, saved, edited or added to an address book;
(d) extracting a web address (hyperlink) and allow it to be used, edited, saved or added to an address book or browser favourites.
(e) extracting a time for a meeting and allow it to be used, saved, edited and added to an agenda as an entry
(f) extracting a number and saving it to one of the device applications
(g) extracting a real noun and providing options to search for it or, look it up on the web (WAP or full browser).

The extent to which this can be done depends on the intelligence in your handset (in essence its parsing capacity and interoperability with other applications and common clipboard where this data is normally stored for use in other applications). Today, nearly all phones support extraction of phone numbers, email addresses and web addresses from a text message. This is normally made available when the user is reading the message by the content being underlined (as a hyperlink or equivalent); the user then simply selects ‘Options’ (as found on Nokia telephones, or its equivalent on a different make of handset) and ‘Use’ (as found on Nokia telephones, or its equivalent on a different handset) and then depending on the content type, further context sensitive options (e.g. with a street address it might offer—Look up, Navigate, Save in Address book, etc. . . . ).

B.2 VoicemailManager™: Voicemail Management Application

This application can be used in either stand-alone or as integral part of the VoicemailView Voice to SMS/MMS system (or equivalent text delivery system) described above at B.1.

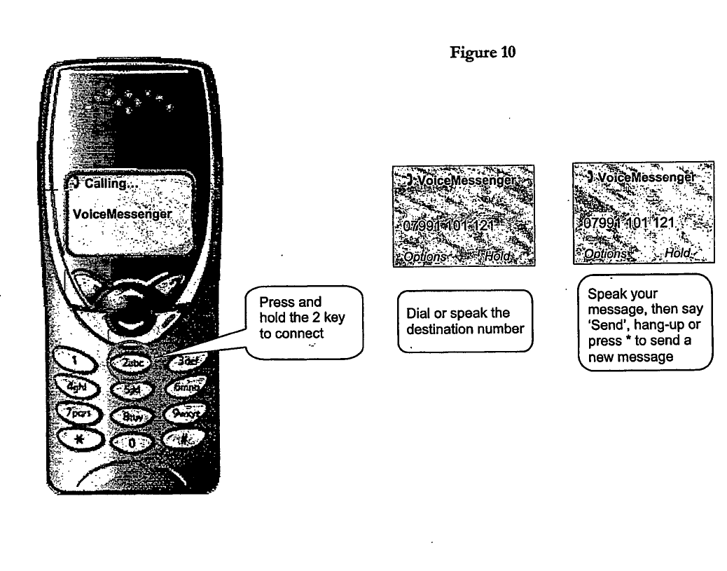

The Voicemail Management application gives a user a GUI (Graphical User Interface) in addition to the standard audio prompts they are used to receiving when accessing and managing normal audio voicemail. When a subscriber calls (FIG. 9a) into their audio voicemail using their mobile telephone, they are first taken into their ‘Voicemail Inbox’ and then presented with the controls shown in FIGS. 9B to D.

For programming purposes, these controls will nearly all relate to standard DTMF tones that the voicemail system uses as input to it when the user currently presses keys on their phone's keypad.

FIG. 9A shows the user calling Voicemail; FIG. 9B shows how a new management application has been invoked which first displays an Inbox's contents (here, 3 new audio calls and 2 stored audio calls) of all voicemails. The options menu operates as follows:

| Item listed in Options Menu | Action |
|---|---|
| Play All | Plays all messages in sequence |
| Delete All | Offers which to delete - all New or all |
| | Stored - and deletes them all |
| Mark all heard | Moves all New messages into Stored folder |
| Forward to | Forwards message to another subscribers |
| | inbox |
| Store | Store - only available in New messages or |
| | during play back - moves message to Stored |
| | folder |

Referring to FIG. 9C, if the user selects which category of audio voicemail he wishes to listen to (i.e. new or stored), he is then shown a menu list of the audio voicemails in that category, each identified with sender name if available, or failing that, the caller number. The transcribed text message ideally has added to it the caller name by the transcription service. This includes notifications when a user turns off the voice-to-text conversion in VoicemailView (i.e. they want plain voicemail) so that they will now be able to see the name of the person who has left them a voicemail before deciding whether to dial-in and listen to it/them. The user can readily navigate to and select the audio message he wishes to listen to. Once a message is selected, then, as shown in FIG. 9C, new Voicemail controls are displayed on screen. Their function is as follows:

| Voicemail | |
|---|---|
| control | Action |
| 1 Erase | Erases current message - returns to previous screen, New or |
| | Stored folder view for user to select which message to now |
| | listen to, or goes straight to playing next message. |
| 2 Next | Skips to next message. At end of messages, goes back to |
| | previous screen, New or Stored folder view. |
| 3 FFW | Fast forwards through message whilst button held. At end |
| | of message, stops and shows next message to be heard |
| | (New or Stored folder view) or at end of all messages, |
| | goes back to top level view (New & Stored folder view) |
| 4 REW | Rewinds back through message whilst button held. At end |
| | of message, stops and shows previous message to be heard |
| | (New or Stored folder view) or at end of all messages, goes |
| | back to top level view (New & Stored folder view) |
| 5 Previous | Skips to previous message. At beginning of messages, goes |
| | back to previous screen, New or Stored folder view. |
| 6 Call back | Calls user back and ends Voicemail call. |
| 7 Text | Opens up Text (SMS or MMS) application with callers |
| message | number selected as default recipient for user to send them a |
| | text message. |
| 8 Forward | Forwards message to another subscribers Voicemail inbox. |
| 9 Add to | Adds number to contacts through phone's standard |
| contacts | contacts/address book application. |
| 0 Configure | Configures voicemail - standard options for Record New |
| | Greeting, Turn Greeting on/off, etc . . . |
| | Integrates into existing phone software for configuring |
| | Divert behaviour - e.g. divert on busy/no answer/phone |
| | off to voicemail or specified number. |

During this process, the user is always offered the aural navigation options which are synchronised with what is shown on-screen, so that they have the best of both worlds. With the use of simple command based Speech Recognition, the user may just speak the command they want to execute, so if the user wants to play new messages, they would just say “Play” and the VoicemailManager engine would recognise this command and do just that—play the message.

Note: The exact numbers keypad numbers) and their related functions will be those of the existing voicemail system and so will vary by network operator/voicemail system.

B.3 VoiceMessenger™: Speech to Text (SMS/MMS) Service

It is often preferable for users to want to send a message in text format, rather than voice—e.g. if they do not want to disturb the receiver, but want to get the message to them. But it is often difficult for people to thumb-type text on a small alpha-numeric keypad. They may also be mobile, such as walking, or in a car or have only one hand available, or be unable to type, such as whilst driving. The VoiceMessenger™ speech to text service addresses this need.

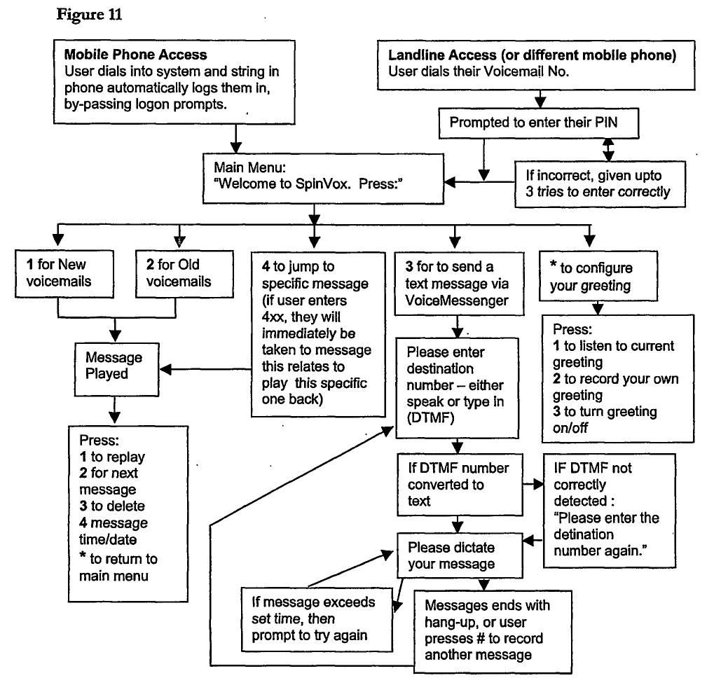

The user goes into their Messaging/Text application running on their mobile telephone, simply selects the message recipient either from their phone's address book, or types their number in, then selects the new VoiceMessenger option, as shown in FIG. 10, by pressing and holding the ‘2’ key. The user might also be connected to the service to start with and will then simply speak the number or the name to a local (on the mobile telephone) or a remote voice recognition engine which will take the user through the process.

When connected to the remote VoiceMessenger Engine, the user simply speaks his message and the remote VoiceMessenger Engine records it, and then sends the audio file for conversion to text using the human operator based voice transcription system. The text format message is then packaged as a SMS/MMS (email or other appropriate messaging system) and sent through the SMS/MMS etc. gateway. The user will be given aural prompts for controlling the input, hearing the conversion and sending the message.

C. Extensions

C.1 MMS Voice-notes to Text

A user with an MMS enabled phone will be able to send voice-notes via an MMS which the human operator based voice transcription service will then transcribe and send on to their desired destination. They can also have their Voicemail converted and sent to their phone in MMS format if preferred.

C.2 Automated Voice Recognition

This is to speed up the processing of inbound voice files and reduce operating costs. The prime function will be to auto-detect spoken phone numbers, and detect language to route audio files to the correct human operator staffed transcription bureau. It will also be used for detecting names and spoken numbers and addresses from the users online phone-book (see below) and commands for VoicemailManager controls.

C.3 Online Address Book

There will be two forms of online address book that a user will be able to use when connected to SpinVox services by simply saying the name of the person they want to say:
SpinVox online phone book—via user web login, they will be able to add names and numbers of people they want in their SpinVox online address book.
Synchronisation with their Microsoft Outlook (Express or full version) or other e-mail/PIM/Addressbook client—this allows them to have all their contacts online and not only be able to say the name of the recipient, but also determine the type of message they want sent: SMS, MMS, email, fax, etc.
With a Network Operator, it is possible also to offer SIM backup function and then offer their SIM phonebook to them to call a name up from.
   C.4 Presently Available Services (Presence)

Using Presently Available Servers, users can define what mode they want to be in for receiving communications, e.g. ‘Meeting’ lets a user know before the communicate that the person they want to contact is in a meeting and will accept say SMS/MMS or a VoiceView text message. Once out of the meeting, the user can then change their contact status to ‘Available’ and be contacted by a phone call.

### APPENDIX 1

1. SpinVox Voicemail IVR Structure

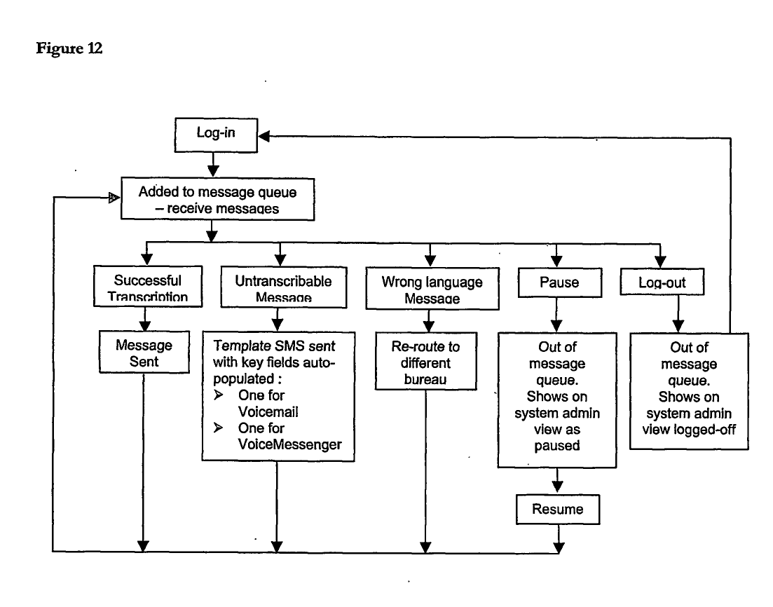

A standard voicemail server system with IVR is the foundation; the IVR is programmed as shown in the FIG. 11 flowchart.

2. VoicemailView

The user's phone will (during technical provisioning shown below) have the ‘1’ key (standard voicemail access key) re-programmed to automatically call the SpinVox voicemail server and have them automatically logged-in (unique phone-number+PIN) which takes them to the top level of the IVR tree.

If at any point the user hangs up, then the session is terminated with the relevant outcome. If this happens during a recording, including a dropped line from another mobile caller, then it is assumed to be the end of a recording, and the system proceeds to the transcription stage.

Each transcribed voicemail will contain a unique number starting with say a ‘4’ (depends on final IVR tree configuration), so that when a user presses and holds ‘1’ to connect to SpinVox's voicemail server, they simply press the unique message i/d—e.g. 403 which takes them to the 3^{rd} message they have in the queue.

2.1 Landline or Other Mobile Phone Access

As shown in FIG. 11, the IVR tree will allow a user to dial in using their unique Divert No. (Voicemail No.) and will then be prompted to enter their PIN.

2.2 Speed-dials

The IVR system will accept a user programming in a speed-dial that allows them to dial their unique SpinVox number+PIN. They are then able to access all features shown above.

2.3 Leaving a VoiceMail

The user's phone is configured to divert to SpinVox voicemail under conditions they define shown below, where the caller will either hear:
Default SpinVox greeting: “Welcome to SpinVox Voicemail. Please dictate your message clearly after the tone.” [tone]
User's own greeting: [User's recorded greeting] [tone]
   Then:
1. System records the caller's voicemail for either the default length (30 secs) or the user defined length (10 s-2 mins or any parameters SpinVox sets).
2. At the end of recording, the caller hears Standard IVR options via prompt:
“Press:
   1. To hear your message
   2. To delete your message and re-record
   3. Re-record your message
   # to end or simply hang-up”
3. If the user exceeds the recording length, then they are prompted: “I'm sorry, you've exceeded the recording time available. Please try again after the tone”
   a. If the user hangs up without recording a new message, then the message is sent for Transcription.
   b. Another variant arises if the user has selected an ‘Advanced Transcribe Option’; this operates such that if the recording time of a message is less than a user set maximum time, then the message is transcribed, otherwise, it is not transcribed but instead a standard notification is sent to the user that they have a new voicemail to listen to in format shown below in 4c. This addresses the fact that users are occasionally sent long voicemails that are more conveniently listened to rather than read. However, for these long messages, a human transcriber may listen briefly to the voice message and write up a very short indication of the subject of the call which is sent to the message recipient. Also, for handsets that support less than a certain amount of text (typically legacy handsets), the system first looks up the user handset and limitations in a Phone database (supplied by SpinVox) and will then offer users relevant recording lengths. E.g. for an older Siemens phone that does not support concatenation and only up to 4 text messages, the system alerts the user that the recording length should be kept below say 30 seconds to ensure most messages fit in their phone and they are told why. Likewise, default recording lengths for these handsets may need to be set to a commensurate length by the system for them.
4. Message is sent to the relevant Transcription queue:
   a. If callers CLID (Caller Line Identification) captured, then autopopulate the ‘From’ field. If not, insert ‘SpinVox VoicemailView’ as the sender.
   b. If transcribable, then text version of message sent to user
   c. If untranscribable, then a template text message with certain fields auto-populated is sent to user:
“You have a new voicemail [from CLI if avaiable] to listen to. Press ‘1’ on your phone to connect to your voicemail, then 4xx to hear this specific message. Thank you. Spin Vox.”
The ‘From’ field is from ‘SpinVox VoicemailView’
   d. Bill according to number of SMSs sent.
5. Text message sent to user and they can choose what to do next as per standard options available to them on their handset.
   3. VoiceMessenger

The above IVR diagram shows how a user accesses VoiceMessenger, whether directly from their mobile phone, or via another phone.

3.1 Speed-dials

The IVR system will accept a user programming in a speed-dial that allows them to dial their unique SpinVox number+PIN+‘3’.

If from their mobile phone, the technical provisioning below will have configured a speed-dial (by default key ‘2’) to dial and log them in (voicemail number+PIN+3) directly to the VoiceMessenger option.

They will then hear a standard prompt:

“Welcome to SpinVox's VoiceMessenger. At the tone, please either speak the destination number or type it in, then dictate the message you wish to send. Hang-up to send, or press # to send a new message.” [tone]

Then:
1. If DTMF tone is undetectable, or confusing (as using * or + for international dialling), then prompt for new number entry:
“I'm sorry, we couldn't detect the number you typed. Please try again and remember for an international number, prefix it with 00, not +” [tone to prompt re-entry]
2. System records for either the default length (30 secs) or the user defined length (10 s-2 mins).
3. At end of recording, user hears Standard IVR options via prompt:
“Press:
   4. To hear your message
   5. To delete your message and re-record
   6. Re-record your message
   # to send new message or simply hang-up”
4. If the user exceeds the recording length, then they are prompted:
“I'm sorry, you've exceeded the recording time available. Please try again after the tone”
   a. If the user hangs up without recording a new message, then the message is sent for Transcription.
5. Message sent to transcription queue with the ‘From’ field auto-populated (as SpinVox knows who the client is):
   a. If transcribable, then text version of message sent to user
   b. If untranscribable, then a template text message with certain fields auto-populated is sent to user:
“I'm sorry, but we weren't able to convert the message you dictated [time/date] [to number if detected]. Please try again in quiet surroundings and dictate clearly. Thank you. SpinVox.” The ‘From’ field is ‘SpinVox VoiceMessenger’.
   c. Bill according to number of SMS's sent or MMS size (KB).
6. Text message sent to recipient and they can choose what to do next as per standard options available to them on their handset
   4. Technical Provisioning

During Technical Provisioning, user data (handset, network, etc. . . . ) will be re-used to confirm to the user what they have selected.

Key will be the system sending the user SMS messages to part automate the configuration of the user's handset (diverts & V.Card for VoiceMessenger) and confirmation of successful setup. These messages are all sent as High Priority to ensure user/salesperson is not left ‘hanging’ whilst waiting for configuration SMS to arrive.

The steps are:

Step 1: handset selection, from a drop down list shown on the provisioning screen (usually at the point of sale)

Step 2: Voicemail View setup:
<CREATE STRING AS FOLLOWS: ‘+COUNTRY CODE_USERS UNIQUE VOICEMAIL NUMBER_p_PIN NUMBER _#’>>>>THIS IS CALLED SPINVOX VOICEMAIL NUMBER AND IS UNIQUE TO EACH USER!>

Step 3: Call diverts selection: this explains how the mobile phone is normally setup to divert to the user's voicemail (under all the following conditions). The user can change these if he specifically wants it to divert to another person or number, and not his own voicemail
<USSD Strings . . . (line of digits) created based on above selections used to configure handset sent as a High Priority SMS with 4×USSD strings the user needs to reply to/action.>

Step 4: Call divert setup via SMS. Tells the customer that he has just been sent a SMS and should click on a specific button on the provisioning screen when received (or a different ‘not received’ button if not received within 3 minutes).

Step 5: Call divert setup: SMS. The provisioning screen informs the user that if he has received the configuration SMS, please do the following:
1. Open SMS message
2. Select ‘Options’ (database to have name of function for each handset)
3. Scroll & Select ‘Use Number’
4. You will now see 4 numbers, select the first number and press ‘Send’. You will now see the number being dialled and ‘Requesting’ displayed on your mobile's screen. If you receive a confirmation message, repeat this step for the remaining 3 numbers.

Step 5: Call divert setup: Mobile phone. The provisioning screen informs the user:

On your mobile handset:

1. Select ‘Menu’2.
<IMPORT VOICEMAILVIEW DATA FROM DATABASE FOR
SPECIFIC HANDSET... TELLS YOU WHAT TO DO / WITH ‘+
COUNTRY CODE_USERS UNIQUE VOICEMAIL
NUMBER_p_PIN NUMBER_#’>

Step 6: Select delivery method. The provisioning screen allows the user to select how he would like to receive voicemails once they are converted to text (typical options are SMS, MMS, MMS with the audio file, e-mail, e-mail with the audio file). The system then sends an appropriate vCard to the user's mobile telephone.

Step 7: Voice Messenger setup. The provisioning screen informs the user:

Please do as follows:
We have just sent you an SMS-VCard. When you have received it, please do the following:
1. Accept and save the VCard on your mobile phone without modifying it—go to step 2.

If you have not received this message within 5 minutes, or cannot save the VCard, please do the following:

Create a new ‘Contact’ called ‘VoiceMessenger’ that has the following number:

+ COUNTRY CODE_USERS UNIQUE VOICEMAIL
NUMBER_p_PIN NUMBER_#,1′

If you don't know how to add new ‘Contact’, please click here—(go to ‘how to’ page, with info pulled from database to—tell you what to do)

2. <IMPORT VOICEMESSENGER SPEED DIAL CONFIG. DATA
FROM DATABASE FOR SPECIFIC HANDSET... TELLS YOU WHAT
TO DO / WITH>

Step 8: Congratulations screen:

Thank you for choosing SpinVox Services.
You will now receive your VoiceMails as Text, and don't forget that you can always hear the originals by simply pressing and holding the ‘1’ key on your phone—to connect to your SpinVox Voicemail account.
To speak a Text Message—press and hold ‘2’ (or the key you designated as VoicemailView) and you will instantly be connected to VoiceMessenger. Clearly dictate your number and message—you say it . . . we text it!
You can always access VoiceMessenger by pressing and holding the ‘1’ key and following the prompts.
You can view your account settings, view statements and manage your SpinVox account at www.SpinVox.com—using your Mobile Phone number and PIN.

If you have not already printed or recorded your PIN number, here it is again
1234
   5. Transcribe Assistant

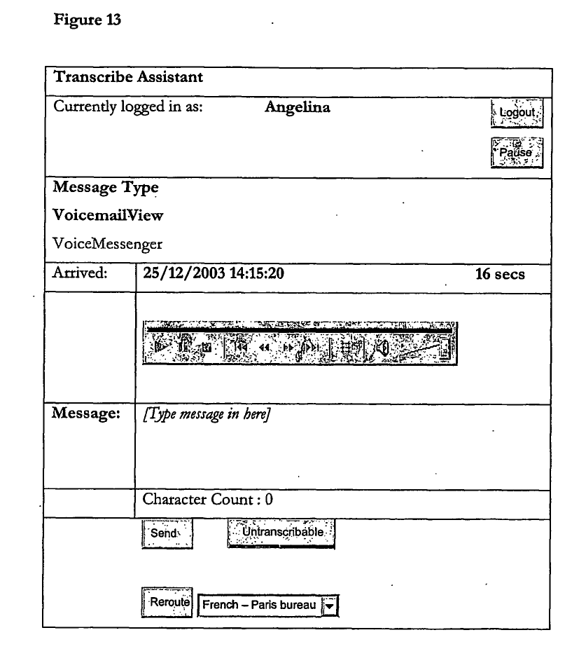

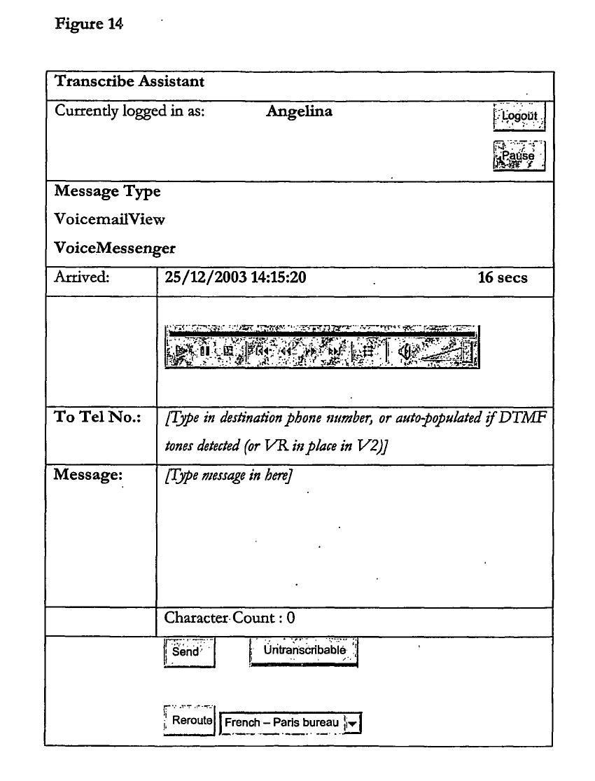

This is provided to a human operator transcriber when they log-on to their account. All they need is a web browser, sound card, media player capable of playing and controlling playback of the media files or streaming protocol, and high-speed internet access. FIG. 12 shows the process flowchart for transcription. Each Transcriber logs in and starts receiving VoicemailView (see FIG. 13 for the screen into which they type the transcribed message and from which they cause the message to be sent), or VoiceMessenger audio files to be transcribed (see FIG. 14), one at a time. While logged-in there are only 2 states: message currently in the process of being transcribed, and pause.

5.1 Transcriber Control Panel Buttons (see FIG. 13):

Transcription completed
Transcription undecipherable—as per 2 & 3 above:
   For VoicemailView, an automatic SMS is sent to them with fields auto-populated where available, with the following text:
   “You have a new voicemail [‘from CLI’ if available] to listen to. Press ‘1’ on your phone to connect to your voicemail, then 4xx to hear this specific message. Thank you. Spin Vox.”
   The ‘From’ field is from ‘SpinVox VoicemailView’
   For VoiceMessenger, an automatic SMS is sent to them with fields auto-populated where data is available, with the following text:
   “I'm sorry, but we weren't able to convert the message you dictated [time/date “to tel no.” if available]. Please try again in quiet surroundings and dictate clearly. Thank you. SpinVox.”
   The ‘From’ field is ‘SpinVox VoiceMessenger’.
Pause and re-queue current message
Re-route current message to different language bureau, menu to select language or “unknown”. Transcriber taken back to queue to receive new message.
   5.2 Phone Numbers:
In the case of VoicemailView, the ‘From’ field is auto-populated with either the CLID captured when the caller left the message (inserted into the message header), or “SpinVox VoicemailView”
In the case of VoiceMessenger, the ‘From’ field is either auto-populated for the Transcriber if the user used DTMF, or if not, the Transcribe Assistant provides a field for the Transcriber to type it in.

Note: For User Data Protection reasons, the Transcriber will never see auto-populated telephone fields (or other user data fields), so the system will not show these unless it requires the Transcriber to type the destination number in.

5.3 Spell Checker

When the Transcriber hits ‘Send’, the system will automatically spell check the message and if any errors occur, correct them and display the corrections to the Transcriber with a prompt ‘Accept & Send”, or allow them to manually correct (as there might be a particular spelling they want).

To do this properly, the spell checking process will include a real-noun dictionary relevant to the geographic area and culture of the user. So for example, in the UK the real-noun dictionary will contain not only English names, but place names, landmarks, road-names, chain establishment names (e.g. pubs, bars, restaurants, etc. . . . ), etc. . . .

Where there isn't a match, the Transcriber just double clicks on the underlined word and is offered the closest matches. If need be, they can rewind and re-listen to that part of the message to make the appropriate selection.

5.4 Transcription Bureau Manager

They can view the statistics for all the Transcriber accounts they own below them. They will be able to view and analyse:
No. of transcriptions by type (sign-up, support)—hourly, daily, weekly, monthly, yearly
No. SMS's sent by type—hourly, daily, weekly, monthly, yearly
Queue times—hourly, daily, weekly, monthly, yearly
Average message length by type—hourly, daily, weekly, monthly, yearly
Transcriptions times/rates—hourly, daily, weekly, monthly, yearly
Variance in transcription times/rates by type—hourly, daily, weekly, monthly, yearly
All of these by Transcriber account
No. and % of messages untranscribable by type—daily, weekly, monthly, yearly
No. and % of messages sent to different bureau for transcription—daily, weekly, monthly, yearly
Transcription accuracy—done by taking a random sample daily and measuring accuracy against original (CCA Manager does this & inputs result into system) and feedback from CCA on trouble tickets. The worst of these two figures is the accuracy.

### APPENDIX II

### Transcription Services Requirements

These are the requirements for the Transcription Services to be used for both VoicemailView and VoiceMessenger services.

Requirements

The key requirement is to deliver the actual message, not all the redundant information which is often spoken and left in a message.

REQUIREMENT

```
Confidentiality
The Transcription service must minimally provide complete confidentiality of messages it
transcribes within the Data Protection Act 98 or other legislation in force at the time.
    All transcription employees must have signed a confidentiality agreement before being
    able to deal with any messages and must not divulge, share, copy, forward or otherwise
    share any user information
    Message and number disassociation to protect the user's information:
        In the case of VoicemailView, the transcriber will not be shown the user's phone
        number they're sending the text message to
        In the case of VoiceMessenger they will not see the caller's number, only the
        destination number
    Each Transcriber will have a unique logon name and password. The system then records
    every transcription they make so we have complete system transparency. This data is
    available to the Transcription Bureau Manager (who creates and manages the Transcriber
    Accounts) and the SpinVox Systems Administrator
    Communications between SpinVox's systems for messages in either direction must be
    secure - use industry standard encryption (e.g. RC4-124, RSA-124, SSL3, etc . . .)
    Access to saved messages on servers (or elsewhere) must be secure
Conversion is 99% + accurate
If the user receives a text message, it will be intelligible - 99% accurate to original voice file
message.
All numbers, phone numbers, email addresses, web addresses, street addresses will be correctly
converted.
Character Set 100% compatible with SMS/MMS allowed characters
Characters used during transcription are compatible with the SMS/MMS system resulting
message will be sent through.
Concatenation of messages is meaningful
User will clearly know to continue to next message to continue reading transcription. If system
doesn't automatically provide obvious prompt to do so, then insert ‘1 of 2’, ‘2 of 3’ or the like.
Regional Accents and Sayings
Transcriptionists must be able to deal with the various regional accents and sayings that occur in a
country. For instance, in the UK alone, there are over 12 regional accents ranging from the
‘posh’ South-Eastern accent to the thick Glaswegian accent of West Scotland to the lilted Irish
accent. These should be translated correctly and in their form of saying things. Routing of a
message to transcribers with the appropriate capabilities may be provided.
Speech Artefacts are removed
Typically speech contains much redundant ‘noise’, e.g.: ‘ummms’, ‘ahhh's’, ‘errr’, ‘ehmm’, pauses,
breaths, coughs, sneezes and other typical speech artefacts. These clearly mustn't be included in
the transcription.
Obvious repeats are removed
Often a message will contain repeated phrases or names to clarify what is being said. These
shouldn't be included.
E.g.
Spoken message: “See you outside Waxy O'Connors, that's Waxy as in candle wax and
O'Connor as in Irish singer Sinead O'Connor.”
Transcription should read: “See you outside Waxy O'Connors.”
Abbreviations
Standard abbreviation of common terms should be used:
```

| | |
|---|---|
| Spoken | Abbreviation |
| Apartment | Apt. |
| Number | No. |
| Telephone Number | Tel. |
| Fax Number | Fax. |
| Example | E.g. |
| Okay | ok |
| Electronic Mail | email |
| Internet Website | website |

```
(i.e. no http:// required)
Numbers
Whenever a number is spoken, the numeric format will be written down.
E.g. “See you at seven forty five tonight” = “See you at 7:45pm”
E.g. “We'd like to order eleven thousand, seven hundred and eighty eight nuts D4 size.” = “We'd
like to order 11,788 nuts D4 size.”
E.g. “Jane lives on eleven seventy five Park View, apartment twenty three on the third floor” = “
Jane lives on 1175 Park View, apt. 23 on the 3^{rd} floor.”
Phone numbers
To save character space, phone numbers are a single string of numbers with no spaces:
E.g.: 07798625155, not 07798 625 155 as two additional space characters are being used.
International Prefixes
If phone number is given with 00 for international dialling, then convert this into a ‘+’.
e.g. 00442075864103 should be +442075864103.
Again this saves character spaces and correctly defines the number for international dialling prefix
which is interpreted by the local Network for the correct international dial out code which isn't
always 00 (e.g. in US it's 011).
Spell Checking
Messages must be correctly spelt and it is suggested that the relevant spell checker is used for all
messages - e.g. UK English for the UK, US English for the US, etc . . .
Real Nouns and Place Names
The dictionary/spell checker used must include Real Nouns (names) and Place Names to assist in
getting the information in the message right 1^{st} time.
Events Planning - Daily calendar of events, celebrations, News, etc . . .
There are several aspects of this:
(i) Cultural Sayings
In multi-cultural societies, it is important to know that on many days a certain community will be
celebrating something. For example the Hindi new year (Divali) is not the same as the main UK
new year, so on Divali, Transcribers must be prepared to hear greetings and wishes with this and
other associated words in it and know how to spell them or what a message's context might
mean.
(ii) Normal annual events - Easter, Christmas, New Year, etc . . .
(iii) Sporting events - national leagues, world cups, F1 events, sailing events, etc . . .
(iv) Media events - Oscars, BAFTA, etc . . . winners
(v) Unexpected events - like the recent ‘Twin Towers’ attack, the bombing in Madrid, War in
Iraq, etc . . .
The local Transcription Bureau Manager must have a full calendar of all cultural, social and
sporting events which they must plan for at least 2 days in advance. In addition, this will be
critical to determining the likely load balancing required with staff. For instance, at the end of the
recent England Rugby world cup win, the text messaging and voicemail loads in the 2-3 hours
that followed the match probably exceeded 300% of their normal levels and there would have
been lots of references to players names, technical words used in the game (try, conversion, ruck,
mall, etc . . .), foreign cities and locations, and of course the following day all the traffic related to
people getting back from the event, etc . . . which will naturally skew the load balancing again.
Undecipherable words
After the best attempt has been made to figure out what the word might be (could be the name of
a bar or place that is outside the normal vocabulary), a question mark in brackets will be placed
after it.
E.g.
Spoken message: Meet you at Jongleurs at 6 tonight.
Transcription: Meet you at Junglers(\) at 6 tonight
Gaps or line drop outs
The message may contain ‘drop-outs’, ‘gaps’ or other interference due to temporary Network
coverage issues. In this case, insert a ‘_’ where the word(s) are missing.
E.g. “John, it's Mike and I'm   late   so see you at 6pm.”
This will likely prompt the user to dial-in to listen to the original and see if they can make sense of
the message.
More than 3 drop outs:
In the case the message is unintelligible due to a high number of drop outs (3 or more), then use
the ‘Undecipherable’ option to send the user a notice that they need to either listen to a voicemail
or try speaking their text message again.
Undecipherable voice messages
The user will be notified via a text message using a standard template that there are
undecipherable voice messages for them to listen to:
VoicemailView
The standard text will say, “You have x new voicemail(s) to listen to that couldn't be converted.
To hear them, please connect to VoicemailView by holding and pressing 1.”
Then the following fields will be automatically populated:
    Caller [tel no” or [“Private No.”] when CLI suppressed
    [time/date]
    A [unique i/d] so that user can go straight to that message
VoiceMessenger
The standard text will say “We're sorry we couldn't convert the message you just dictated. Please
try again speaking slowly and clearly. Thank you!”
Then the following fields will be automatically populated:
    [Time and date] they attempted to send message
    To: [Tel No.] they were attempting to text
Mood or other implied Context
When it is clear that the person leaving the message is also using mood as part of the message,
then the transcriptionist will include the following at the beginning of the message:
```

| | |
|---|---|
| [laughing] | Laughing |
| [crying] | Crying |
| [whispering] | Whispering |
| [shouting] | Shouting/Screaming (unless doing so to overcome background noise as |
| | when in a bar or station in which case ignore) |
| [screaming] | Screaming as when someone is highly distressed, in trouble or frightened. |
| [frightened] | When the person is obviously frightened |
| [angry] | Angry as shouting and/or banging fists (should be obvious from the |

content of the message)
When the mood is unclear (e.g. may be just the way that person talks or the context that they're
in), then don't add this in.
VoiceMessenger Text'isms
It is becoming common to insert text symbols to represent emotions (emoticons). The following
will be published and will be supported. This is the set that we will support and publish on our
website.
The official full listing of SMS-Speak is at:
http://sites.ninemsn.com.au/minisite/web2sms/help/smsdict.asp
During dictation of the VoiceMessenger message, the user may say “Insert symbol-name” and the
transcriber will insert the appropriate symbol.
E.g. “Thanks for confirming our trip. Insert smiley. Bye!” = “Thanks for confirming our trip:-)
Bye!”

| | | | |
|---|---|---|---|
| Symbol | Symbol Name | Symbol | Symbol Name |
| :-) | Smiley | O :-) | An angel |
| :-D | Laugher | :-9 | Salivating |
| ;-) | Twinkle | :-<> | Surprised |
| :-* | Kiss | %-6 | Not very clever |
| :-( | Sad | :-( ) | Shocked |
| :′-( | Crying | :-o zz | Bored |
| :-c | Unhappy | :-\ | Sceptical |
| :-∥ | Angry | : @ | Shouting |
| :-(0) | Shouting | :-o | Appalled |
| :-< | Cheated | :-X | Nor saying a word |
| >:-( | Very angry | \|-I | Sleeping |
| :-O | Wow | %-} | Intoxicated |
| :-\| | Determined | :-v | Talking |
| :-* | Bitter | | |

```
Punctuation
Normal punctuation should be used such as capitals at the begging of sentence, full stops,
question marks, exclamation marks, colons and semi-colons where it is clear that the intonation
or the grammar requires it.
The Grammar checker used in the Transcribe Assistant ought to help eliminate mistypes.
Text is delivered promptly
Time taken for text message to arrive on receiver's phone from end of voicemail recording is on
average 2 mins:
    80% within 2 minutes
    10% within 3 minutes
    10% within 5 minutes
Queuing and load-balancing will be necessary to ensure optimal throughput of messages.
```

1. A method of generating a SMS or MMS text message from a first mobile telephone for receipt by a second mobile telephone, comprising the steps of:
(a) receiving a voice message at a server, the voice message having been sent from the first mobile telephone by an end-user originator;
(b) converting the voice message to an audio file format;
(c) sending or streaming the audio file over a wide area network to a voice to text transcription system comprising a network of computers;
(d) one of the networked computers playing back the voice message to an operator;
(e) the computer receiving as input the original voice message, intelligently transcribed by the operator as a transcribed text message;
wherein the method is characterised in that:
(i) the end-user originator selects an option or function of the first mobile telephone that causes the voice message to be remotely transcribed to a SMS or MMS message for display on the second mobile telephone; and
(ii) the computer causes the transcribed text message to be sent to the second mobile telephone as the SMS or MMS message.

2. The method of claim 1 in which the transcribed text message has added to it the time and date that the voice message was originally received at the server.

3. The method of claim 1 in which a further voice message is originated at a mobile telephone or at a landline telephone and a SMS or MMS text message is generated from that further message using the method of claim 1.

4. The method of claim 1 in which the transcribed text message has added to it the caller name and/or number (MSISDN).

5. The method of claim 4 in which the transcribed text message is displayed on the device as though it was sent directly from an originator of the voice message.

6. The method of claim 1 in which the computer does not display to the operator the telephone number associated with the wireless information device.

7. The method of claim 1 in which the computer displays to the operator an option to re-route the audio file to a different computer with an operator that is more suited to transcribing the voice message because of linguistic, dialect, or cultural reasons.

8. The method of claim 1 in which the computer provides the operator with a searchable list of specialised terms that are relevant to cultural sayings, regular events, sporting events, media events, other kinds of newsworthy events to assist the operator in accurately transcribing those specialised terms.

9. The method of claim 1 in which the operator represents the mood of the caller leaving the voice message in the transcribed text message using either a written description or an emoticon.

10. The method of claim 1 in which the operator succinctly summarises the voice message.

11. The method of claim 1 in which the operator summarises the voice message to fit it the 160 character SMS limit or subsequent concatenated text messages.

12. The method of claim 1 in which the operator omits from the transcribed text message any hesitations, artefacts, or unnecessary repetitions present in the voice message.

13. The method of claim 1 in which the text message is sent to the wireless information device in a format previously specified as appropriate by the user of the device.

14. The method of claim 1 in which the originator of the voice message speaks the name of the intended recipient and the operator or a speech recognition system is able to extract the relevant telephone number of the wireless information device, email address or other address by looking up that name in a web-based address book associated with the originator.

15. The method of claim 1 comprising the further step of parsing the transcribed text message and using the parsed data in an application running on the wireless information device.

16. The method of claim 15 in which parsing and using the parsed data involves one or more of the following:
(a) extracting the phone number spoken allowing it to be used (to make a call), saved, edited or added to a phone book;
(b) extracting an email address and allowing it to be used, saved, edited or added to an address book;
(c) extracting a physical address and allowing it to be used, saved, edited or added to an address book;
(d) extracting a web address (hyperlink) and allow it to be used, edited, saved or added to an address book or browser favourites;
(e) extracting a time for a meeting and allow it to be used, saved, edited and added to an agenda as an entry;
(f) extracting a number and saving it to one of the device applications;
(g) extracting a real noun and providing options to search for it or, look it up on the web (WAP or full browser).

17. The method of claim 1 in which, for devices that support less than a certain amount of text, there is an initial look up of the text limitations in a database and then an automatic suggestion of appropriate maximum recording time.

18. The method of claim 1 when used in conjunction with an automated voice recognition system to speed up the processing of the audio file.

19. A text message which has been transcribed from a voicemail and is provided to a wireless information device using the method of claim 1.

20. A mobile telephone programmed with an application that enables an end-user originator of a message to cause a SMS or MMS text message to be generated from that message by the performance of the method of claim 1.
